(19) United States
(12) Patent Application Publication
(10) Pub. No.: US 2022/0222844 A1
(43) Pub. Date: Jul. 14, 2022

(54) METHOD, DEVICE, AND PROGRAM FOR MEASURING FOOD

(71) Applicant: NUVILABS CO., LTD., Suwon-si (KR)

(72) Inventor: Dae Hoon KIM, Gunpo-si (KR)

(73) Assignee: NUVILABS CO., LTD., Suwon-si (KR)

(21) Appl. No.: 17/147,478

(22) Filed: Jan. 13, 2021

(51) Int. Cl. G06T 7/62; G06T 7/73; G06T 7/50; G06K 9/32; G06K 9/62; G06F 16/53

(52) U.S. Cl. CPC G06T 7/62; G06T 7/74; G06T 7/50; G06K 9/3208; G06K 2209/17; G06K 9/6201; G06K 9/627; G06F 16/53; G06K 9/6228

(57) ABSTRACT

A method for measuring food is provided. The method calculates an amount of food based on information on a size of a plurality of spaces, a depth of the plurality of spaces, and a capacity of the plurality of spaces formed in a tableware containing the food and an image photographed by photographing.

### TECHNICAL FIELD

The present invention relates to a method for measuring food, and in particular, to a method of measuring the amount of food using volume.

### BACKGROUND

In recent years, as more people want to maintain a healthy diet such as well-being and diet, the demand for food measuring technology is increasing.

Even in places where food is served to multiple people, such as schools, companies, the military, government offices, hospitals, by measuring the amount of food served and the amount of leftover through measurement of the amount of food served and distributed to people, there are many advantages such as being able to conduct efficient food distribution in anticipation of the amount of demand and supply and to manage the calories of those who are served of the food.

However, since most of the currently known technologies are merely searching for images taken through a camera, the accuracy is remarkably degraded, and there is a problem that a larger error occurs in subsequent steps such as calorie calculation since the accuracy in image search is poor.

Accordingly, the inventor has come up with an invention that can accurately analyze and calculate food, not just searching for food by image.

The above information disclosed in this Background section is only for enhancement of understanding of the background of the invention and it may therefore contain information that does not form the prior art that is already known to a person of ordinary skill in the art.

### SUMMARY

The present invention for solving the above-described problem is directed to providing a method for measuring food for calculating volume of food by using height information on each pixel of an image photographed through a stereo camera or a depth measuring device.

In addition, the present invention may provide a method for measuring food for correcting the calculated volume of food by using information of a serving tableware.

The technical problems to be solved in the present invention are not limited to the technical problems mentioned above, and other technical problems not mentioned will be clearly understood by those of ordinary skill in the art from the following description.

The method for measuring food performed by a computer according to an embodiment of the present invention for solving the above-described problem includes steps of: receiving image data of tableware containing food and depth data of the tableware containing the food, when the tableware containing food is photographed by a photographing unit; calculating a tilt of the tableware image from the tableware image data, and correcting the image data of the tableware containing food and the depth data of the tableware containing food according to the calculated tilt; extracting a shape of the tableware using the corrected depth data of the tableware containing food, and based on this, extracting food image data accommodated in the tableware from the corrected tableware image data; determining a type of the food based on the extracted food image data; and calculating volume of the food based on the corrected depth data of the tableware containing food.

In addition, a server for measuring food according to an embodiment of the present invention for solving the above-described problem includes a receiving unit to receive image data of tableware containing food and depth data of the tableware containing the food, when the tableware containing food is photographed by a photographing unit; a correction unit to calculate a tilt of the tableware image from the tableware image data, and correcting the image data of the tableware containing food and the depth data of the tableware containing food according to the calculated tilt; an extraction unit to extract a shape of the tableware using the corrected depth data of the tableware containing food, and based on this, to extract food image data accommodated in the tableware from the corrected tableware image data; a determination unit to determine a type of the food based on the extracted food image data; and a calculation unit to calculate volume of the food based on the corrected depth data of the tableware containing food.

In addition, a device for measuring food according to an embodiment of the present invention for solving the above-described problem includes a receiving unit to receive image data of tableware containing food and depth data of the tableware containing the food, when the tableware containing food is photographed by a photographing unit; a correction unit to calculate a tilt of the tableware image from the tableware image data, and correcting the image data of the tableware containing food and the depth data of the tableware containing food according to the calculated tilt; an extraction unit to extract a shape of the tableware using the corrected depth data of the tableware containing food, and based on this, to extract food image data accommodated in the tableware from the corrected tableware image data; a determination unit to determine a type of the food based on the extracted food image data; and a calculation unit to calculate volume of the food based on the corrected depth data of the tableware containing food.

In addition to this, another method for implementing the present invention, another system, and a computer-readable recording medium for recording a computer program for executing the method may be further provided.

According to the present invention as described above, there is an effect of calculating accurate volume of food by calculating the volume of food by using height information on each pixel of an image photographed through a stereo camera or a depth measuring device.

In addition, the present invention has an effect of more accurately calculating volume of food by correcting the calculated volume of food by using information on size, depth, and capacity of spaces formed in the serving tableware.

The effects of the present invention are not limited to those mentioned above, and other effects not mentioned will be clearly understood by those of ordinary skill in the art from the following description.

### BRIEF DESCRIPTION OF THE DRAWINGS

The above and other aspects, features, and advantages of the present invention will become more apparent to those of ordinary skill in the art by describing embodiments thereof in detail with reference to the accompanying drawings, in which:

FIG. 1 is a flowchart of a method for measuring food according to an exemplary embodiment of the present invention;

FIG. 2A is a perspective view of a tableware according to an exemplary embodiment of the present invention;

FIG. 2B is a perspective view of a tableware with an identification code attached to the back or side;

FIG. 3 is a perspective view of a tableware containing food according to an exemplary embodiment of the present invention;

FIG. 4 is a perspective view of a tableware in which two foods are stacked in one space in FIG. 3;

FIG. 5 is a perspective view of a tableware with no space division;

FIG. 6 is a flowchart of a method of providing an advanced local model in order to increase the accuracy of determining the type of food;

FIG. 7 is a flowchart of a method for measuring food according to another exemplary embodiment of the present invention;

FIG. 8 is a flowchart of a method of providing restaurant operation information and management information of a taker according to an exemplary embodiment of the present invention;

FIG. 9 is a block diagram of a server for measuring food according to an exemplary embodiment of the present invention;

FIG. 10 is a detailed block diagram of the management unit of FIG. 9;

FIG. 11 is a block diagram of a device for measuring food according to an exemplary embodiment of the present invention;

FIGS. 12 to 15 are perspective views of devices for measuring food according to an exemplary embodiment of the present invention;

FIG. 16 is a screen of a device for measuring food according to an exemplary embodiment of the present invention;

FIG. 17 is a block diagram of a server for measuring food according to an exemplary embodiment of the present invention;

FIG. 18 is a block diagram of a user terminal according to an exemplary embodiment of the present invention.

### DETAILED DESCRIPTION OF THE EMBODIMENTS

Advantages and features of the present invention, and a method of achieving them will be apparent with reference to the embodiments described below in detail together with the accompanying drawings. However, the present invention is not limited to the embodiments disclosed below, and may be embodied in various forms. Rather, the description of the embodiments of the present invention is provided so that this disclosure will be thorough and complete and will fully convey the concept of the invention to those of ordinary skill in the art. Accordingly, the present invention is only defined by the scope of the appended claims.

The terminologies used in this specification are for the purpose of describing embodiments only and are not intended to be limiting to the present invention. In this specification, the singular form also includes the plural form unless specifically specified in the phrase. The terms “comprise” and/or “comprising,” when used in this specification, do not preclude the presence or addition of one or more other elements other than elements mentioned. Like reference numerals designate like elements throughout the specification, and the term “and/or” includes each and all combinations of one or more of the mentioned elements. Although “first”, “second”, and the like are used to describe various elements, it goes without saying that these elements are not limited by these terms. These terms are only used to distinguish one element from another element. Therefore, it goes without saying that the first element mentioned hereinafter may be the second element within the technical idea of the present invention.

Unless otherwise defined, all terms (including technical and scientific terms) used in this specification will be used as meanings that can be commonly understood by those of ordinary skill in the art. In addition, terms defined in a commonly used dictionary are not interpreted ideally or excessively unless explicitly and specifically defined.

Hereinafter, embodiments of the present invention are described in detail with reference to the accompanying drawings.

Prior to the description, the meaning of terms used in this specification is briefly described. However, it should be noted that the description of terms is not intended to limit the technical idea of the present invention unless explicitly described as limiting the present invention, since it is intended to aid understanding of the present specification.

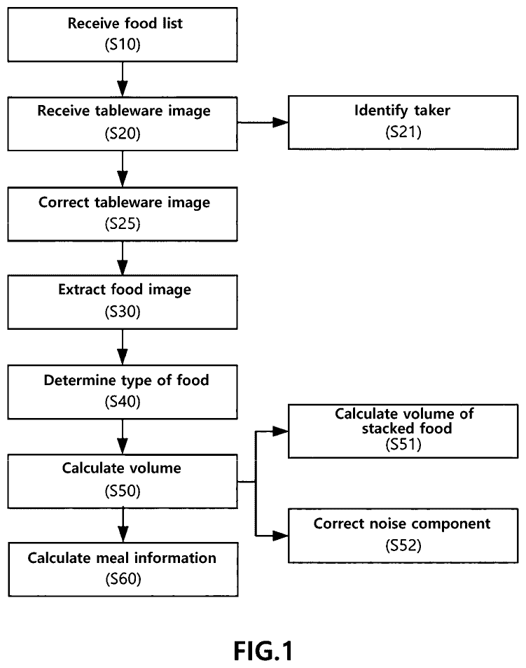

A method for measuring food according to an embodiment of the present invention will be described with reference to FIGS. 1 to 5. The method for measuring food according to an embodiment of the present invention is performed by a computer, wherein the computer refers to a server for measuring food 100 or a device for measuring food 200. That is, the photographing may be performed by the device for measuring food 200, but other steps may be performed by the server for measuring food 100 or the device for measuring food 200.

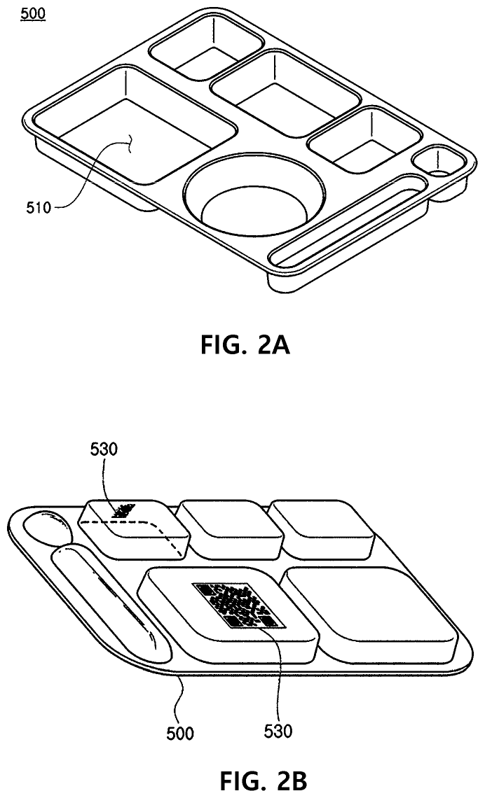

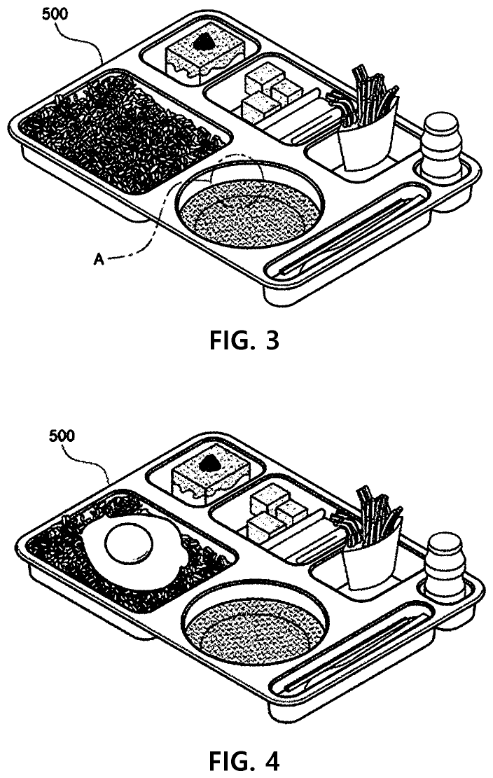

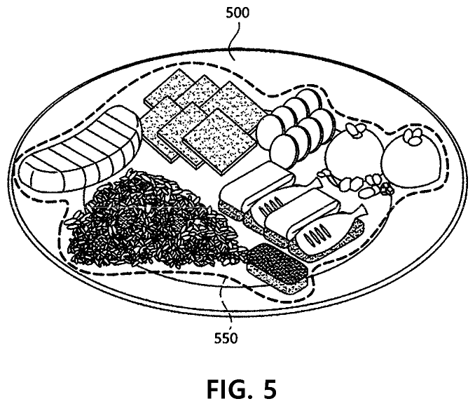

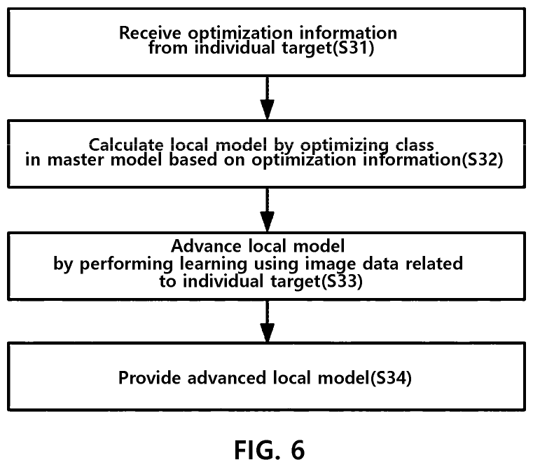

FIG. 1 is a flowchart of a method for measuring food according to an exemplary embodiment of the present invention; FIG. 2A is a perspective view of a tableware according to an exemplary embodiment of the present invention; FIG. 2B is a perspective view of a tableware with an identification code attached to the back or side; FIG. 3 is a perspective view of a tableware containing food according to an exemplary embodiment of the present invention; FIG. 4 is a perspective view of a tableware in which two foods are stacked in one space in FIG. 3; FIG. 5 is a perspective view of a tableware with no space division; and FIG. 6 is a flowchart of a method of providing an advanced local model in order to increase the accuracy of determining the type of food.

The method for measuring food according to an embodiment of the present invention may be performed at a food serving section or a tableware return section of a restaurant, and the restaurant may be a self-service restaurant such as a cafeteria or a buffet, a place where a user moves a tableware 500 to receive food, and may be a place where meals are provided to a group such as a school, a company, or the military. Here, the restaurant may include a food serving section for receiving food or a tableware 500 and a tableware return section for throwing away the leftover and returning the tableware 500 after eating, but is not limited thereto.

However, the method for measuring food according to an embodiment of the present invention is not limited to being performed in a restaurant, particularly a self-service restaurant, and may be performed in other types of restaurants or at home, or may be performed at each seat.

In addition, for convenience of description, the description is made using the tableware 500 with a shape of a food tray divided into spaces 510, but the shape of the tableware 500 is not limited thereto.

Referring to FIG. 1, a receiving unit 110 receives an image of tableware containing food taken through a photographing unit 250 of the device for measuring food 200 at step S20.

The receiving unit 110 normalizes the received image of tableware containing food, and the normalization refers to adjusting or transforming the received image of tableware containing food according to predetermined criteria (e.g., size, brightness, rotation, tilt, etc.).

If the photographing unit 250 can acquire image data and depth data, there is no limitation on the configuration thereof. For example, the photographing unit 250 may include at least one of an RGB camera, a 2D camera, a 3D camera, a Time of Flight (ToF) camera, a light field camera, a stereo camera, an event camera, and an infrared camera, and if it can measure image data and depth data, there is no limitation on the configuration thereof.

Meanwhile, in addition to photographing food or tableware containing food, the photographing unit 250 may photograph biometric information of a taker to identify the taker. Here, the biometric information of the taker may be the face, iris, or fingerprint of the taker, but is not limited thereto. One photographing unit 250 may simultaneously or separately photograph food or tableware containing food and biometric information of the taker, but the photographing unit may be divided into a photographing unit 250a for photographing food or tableware containing food and a photographing unit 250b for photographing biometric information of the taker.

In some embodiments, when photographing the tableware 500 moving along a conveyor belt 270, the photographing unit 250 of the device for measuring food 200 may acquire depth data in addition to image data, even if it includes a single camera. It is because if the single photographing unit 250 respectively photograph the moment when the tableware 500 is located at a first position on the conveyor belt 270 and the moment when the tableware 500 is moved and located at a second position on the conveyor belt 270, this may obtain the same effect as photographing the still tableware 500 using the photographing unit 250 including a plurality of cameras.

Since the camera is a device that recognizes light, it is highly affected by the environment such as light reflection. Therefore, it is necessary to minimize the influence of the environment by taking pictures using the photographing unit 250 including two or more cameras. However, even if photographing is performed using the photographing unit 250 including two or more cameras, since it may be affected by the environment, correction thereof is required.

Therefore, in order to optimize according to the characteristics and environment of the restaurant, the computer may control its learning module to learn the situation of the field through the images taken, and to recognize the environment condition based on filter processing, fixed objects and reference objects (background targets described later).

Meanwhile, when photographing the tableware 500 using the device for measuring food 200 according to an embodiment of the present invention, the device for measuring food 200 may detect identification information 530 on the tableware 500 or identification information on the taker as well as photographing the tableware 500 from the upper side using the photographing unit 250. That is, it is possible to identify the taker by using the device for measuring food 200 simultaneously or separately from the step of receiving the tableware image (S20) at step S21.

Specifically, referring to FIG. 2B, identification information on the tableware 500 may be included in the tableware 500, for example, may be physically included in the tableware 500 in the form of a QR code (Quick Response Code) 530 or a barcode, and in addition to this, identification information in various code types, such as a combination of numbers or letters, and a combination of figures and symbols may be included in the tableware 500. Besides, the identification information on the tableware 500 may be included in the tableware 500 by recorded in various semiconductor devices such as an RFID chip. To this end, the device for measuring food 200 may include an identification information sensing unit 251, and the identification information sensing unit 251 may be placed in the device for measuring food 200 to detect the identification information on the tableware 500 at the same time when the photographing unit 250 photographs the dishes 500 from the upper side.

For example, as shown in FIG. 2B, when the QR code 530 is located on the back or side of the tableware 500, the identification information sensing unit 251 may be located at the lower side to face the photographing unit 250 or be located to recognize the QR code 530 in a horizontal direction, but the location of the identification information sensing unit 251 is not limited thereto, and the identification information sensing unit may be placed in various locations if it can detect the identification information of the tableware 500 at the same time when the photographing unit 250 photographs the top surface of the tableware 500.

In some embodiments, when the identification information of the dish 500 is located on the upper side of the tableware 500, the device for measuring food 200 may not include a separate identification information sensing unit 251, and may identify the identification information of the tableware 500 by analyzing a tableware image measured using the photographing unit 250.

Besides, identification information on the taker may be detected by an authentication unit 160, for example, by applying some methods such as facial recognition which identifies biometric information using image capture of the taker, iris recognition, or fingerprint recognition.

In addition, the authentication unit 160 may detect identification information on the taker by recognizing a tag including an RFID chip held by the taker or a tag including identification information in various code types such as a QR code, a barcode, a combination of numbers or letters, and a combination of figures and symbols.

In the case of using the method for measuring food according to an embodiment of the present invention, various information may be calculated using the measured result, and there may be a difference in information calculated depending on what information the device for measuring food 200 can recognize among information on the tableware 500 and information on the taker 530.

First, if both the device for measuring food 200 installed in the food serving section and the device for measuring food 200 installed in the tableware return section may recognize identification information 530 on the tableware 500, and may recognize only identification information on the taker, information on each taker and information on a group including the corresponding taker may be calculated using the method for measuring food according to the present embodiment.

In contrast, if both the device for measuring food 200 installed in the food serving section and the device for measuring food 200 installed in the tableware return section may not recognize the identification information on the taker, and may recognize only the identification information 530 on the tableware 500, the information on each taker may not be calculated, and only the information on a group including the corresponding taker may be calculated using the method for measuring food according to the present embodiment.

Besides, if the device for measuring food 200 installed in the food serving section may recognize both the identification information 530 on the tableware 500 and the identification information on the taker, and the device for measuring food 200 installed in the tableware return section may not recognize the identification information 530 on the tableware 500 but may recognize the information on the taker, both the information on each taker and the information on a group including the corresponding taker may be calculated using the method for measuring food according to the present embodiment; since even if the device for measuring food 200 installed in the tableware return section may not recognize the identification information 530 on the tableware 500, the identification information 530 on the tableware 500 held by a specific taker may be specified by using the information from the food serving section.

Meanwhile, a food identification device 30 may not include a separate authentication unit 160 and may receive input of identification information from the taker through an input unit (not shown) of the device for measuring food 200.

Therefore, in some embodiments, in the step of receiving, by the receiving unit 110, the tableware image taken through the photographing unit 250 (step S20), the receiving unit 110 may also receive at least one of identification information on the tableware 500 and identification information on the taker in addition to the tableware image.

Subsequently, referring to FIG. 1, a correction unit 150 may perform image correction of the image of tableware containing food at step S25.

More particularly, the correction unit 150 may remove a noise component using the image data of tableware containing food, recognize a tilt of the tableware image, and correct the image into a horizontal state image. The corrected image may be used in a step of calculating volume (S50) described later.

Since the tableware image may be photographed unclear or the tableware image may be photographed while the angle of the tableware is inclined, the correction unit 150 recognizes the shaking or tilt of the tableware image, select the tableware image with the least shaking or tilt, and correct the tableware image into a horizontal state image, which allows to accurately calculate the volume of the food.

First, the correction unit 150 may analyze a plurality of normalized tableware images in order to select a tableware image with the least shaking among the normalized tableware images. For example, the correction unit 150 may check the degree of blurring of the image in units of each pixel, and through this, select a tableware image that has the least shaking and is clear.

Next, the correction unit 150 may calculate a distance from the photographing unit 250 to a plurality of exposed areas for an area in which the tableware 500 is not covered by food and exposed in the tableware image, and may calculate a tilt of the tableware 50 from the tableware image using the calculated distances to the plurality of exposed areas. Next, the correction unit 150 may correct the photographed tableware image to be a horizontal state using the calculated tilt.

Specifically, the correction unit 150 may extract a shape of the tableware 500 using depth information from the depth of tableware image. Since the tableware 500 and the background other than the tableware 500 differ in depth information in the tableware image, using this, the correction unit 150 may extract the tableware 500 from the tableware image.

The correction unit 150 identifies flat areas among areas exposed without being covered by food in the tableware 500, select at least 3 or more points among the flat areas, and identifies depth information of the selected 3 or more points.

Using the 3 or more points, it may be possible to create a virtual plane and check a slope of the plane. That is, the correction unit 150 may calculate a tilt of the tableware 500 using depth information of the 3 or more selected points, and correct the photographed tableware image using the calculated tilt.

In some embodiments, after selecting at least 3 or more points in the flat areas, with respect to the 3 or more selected points the accuracy of the calculated tilt may be improved by using an average depth information of the surrounding points of each point as a depth information of each point and by using a relatively large amount of information to calculate the tilt.

In some embodiments, in the process of calculating the tilt of the tableware 500 using depth information of the selected 3 or more points, a gradient value according to a line connecting each point may be derived, through which the tilt of the tableware 500 may be calculated and the photographed tableware image may be corrected using the calculated tilt.

In some embodiments, the correction unit 150 may calculate the tilt of the tableware 50 from the photographed tableware image by identifying an outline of the tableware 50 from the tableware image and by comparing the outline of the tableware 50 from the photographed tableware image and the outline of the tableware 50 from the non-tilted tableware image that is for use as a reference. Next, the correction unit 150 may correct the photographed tableware image using the calculated tilt.

In addition, since noise may occur according to the situation of the field (shake, light reflection, etc.) in two image data of tableware containing food received through the receiving unit 110, the noise may be removed by comparing the two tableware images.

Next, referring to FIG. 1, an extraction unit 120 extracts food image data accommodated in each space 510 of the tableware 500 from the image data of tableware containing food at step S30.

Since the tableware image includes both the tableware 500 and the food image, the food image data may be extracted from the tableware image. For example, the extraction unit 120 may extract food image data using an artificial intelligence model learned to distinguish food and non-food items. Here, when the tableware 500 includes a plurality of spaces 510, the extraction unit 120 may extract food image data for each space 510.

Meanwhile, referring to FIG. 5, it is shown that a plurality of foods are accommodated in a single tableware 500 with no space division, and since the space is not divided within the tableware 500, the extraction unit 120 may recognize as one whole food image 550 including the plurality of foods. In this case, the extraction unit 120 shall additionally perform a process of dividing and extracting one whole food image data into each food image data.

Next, referring to FIG. 1, a determination unit 130 determines a type of each food based on the extracted food image data at step S40.

The determination unit 130 may determine the food type using the extracted food image data. For example, the determination unit 130 may include an artificial intelligence model learned based on image in order to recognize the type of food, but the method of determining the type of food is not limited thereto.

In the method for measuring food according to the present embodiment, in order to increase the recognition rate of food types, the learned artificial intelligence model may be optimized for an individual target (e.g., an individual restaurant or an individual taker) for which the method for measuring food is used, in the following manner.

First, referring to FIG. 6, the receiving unit 110 receives optimization information for optimizing a learned model from an individual target such as a restaurant or a taker at step S31.

The learned model to be optimized is a master model, and the master model is a model that has been trained to classify types of food by using image data photographed from the device for measuring food 200 or the user terminal 300 or processed results as a data set.

Since the master model is constructed from all the captured image data or processed results used in the method for measuring food as a data set, in order to determine the type of specific food image data, the master model determines what kind of food the specific food image data is from dozens, hundreds, or thousands of food type classes.

Optimizing the master model is to reduce the number of cases for food type classes that need to be considered in order to determine the food type of specific food image data. To this end, it may be possible to obtain optimization information for individual target such as a restaurant or a taker.

That is, the receiving unit 110 may receive optimization information for an individual target. The optimization information may be, for example, information on something consumed by each individual target or something having a high probability of being consumed by a taker that uses an individual target such as menu information sold or provided by an individual restaurant or types of food frequently consumed by the individual taker.

Next, referring to FIG. 6, the determination unit 130 calculates a local model by optimizing a class in the master model based on the optimization information at step S32.

The determination unit 130 calculates the local model for an individual target by selecting a food type class that is highly related to the individual target based on the optimization information and optimizing the class of the master model in a manner of reducing a considered food type class from the master model to a food type class that is highly related to the individual target.

Next, referring to FIG. 6, the determination unit 130 advances the local model by performing learning using image data related to the individual target at step S33.

The determination unit 130 may advance the local model by performing learning of the calculated local model using image data related to the individual target or a result processed in relation to the individual target.

Here, the image data related to the individual target may be image data photographed within an individual restaurant as an individual target or a result of processing image data photographed within the individual restaurant, or image data photographed by an individual taker as an individual target or a result of processing image data photographed by the individual taker.

Meanwhile, in the process of advancing the local model by learning the calculated local model by using image data related to an individual target or a result processed in relation to the individual target, the determination unit 130 may perform learning while changing various variables such as learning parameters and learning cycles in the process of performing learning using the artificial intelligence algorithm, and perform an advancement process using a learning model with the highest accuracy among the performed learning methods.

Next, referring to FIG. 6, the determination unit 130 may provide an advanced local model, and by using this, the determination unit 130 may improve accuracy by determining the type of each food through the extracted food image data at step S34.

In some embodiments, as a preceding step, a step of receiving, by the receiving unit 110, food list information provided by a restaurant (step S10) may be further included.

In this case, in the step of determining the food type (step S40), the determination unit 130 may determine the type of each food by matching the extracted food image data and food list information.

In this way, the determination unit 130 may independently determine the type of food by analyzing food image data, or may determine the type of food by matching with stored food list information, and the method of determining the type of food is not limited thereto.

Next, referring to FIG. 1, a calculation unit 140 calculates a volume of each food by using height information for each pixel (i.e., 3D distance data) of the extracted food image data at step S50.

As mentioned above, since the tableware image was photographed through the photographing unit 250 capable of acquiring depth data, height information (3D distance data) for each pixel is included in the food image data as depth data, and so this may be used to calculate the volume of each food.

Here, the computer includes a database 170 in which tableware images and tableware information including sizes, depths and capacities of the plurality of spaces 510 formed in the tableware 500 are stored.

In addition, the step of calculating volume (step S50) may further include a step of correcting, by the correction unit 150, the calculated volume of each food using the tableware information including the size, depth and capacity of the space 510 in which each food is accommodated.

Since the depth of each space 510 is different according to the type of tableware 500, the correction unit 150 may determine more accurately how much food has been accumulated by using the tableware information. Since the database 170 of the computer according to the present embodiment stores data on the tableware 500 used in a restaurant, the volume of each food extracted using tableware information may be more accurately calculated by using the method for measuring food according to the present embodiment.

For example, when the determination unit 130 determines that the type of food accommodated in a specific space 510 in the tableware 500 is a liquid, the calculation unit 140 may calculate the volume of the liquid by using the tableware information including a location where the liquid and the corresponding space 510 contact each other, and a size, depth, and capacity of the space 510.

When a liquid food such as a ‘soup’ in a specific space 510 such as ‘A’ area shown in FIG. 3, there will be inevitably a portion where the ‘soup’ and the corresponding space 510 contact at a certain height. Using this, the calculation unit 140 calculates the volume of the liquid food by recognizing a position where the liquid food and the corresponding space 510 contact in the tableware image and calculating the volume up to the height of ‘A’ area using the tableware information (size, depth, and capacity) of the space 510.

In some embodiments, additional correction may be performed on a single tableware 500 with no space division as shown in FIG. 5. In the step of calculating volume, when it is determined that a plurality of foods are accommodated in an undivided space within one tableware 500 from the food image data, the calculation unit 140 requests the extraction unit 120 to transmit image data of each of the plurality of foods and calculates the volume of each food.

And the calculation unit 140 may calculate the volume of the whole food using the extracted whole food image data, and correct the volume of each food by comparing the total volume of each food calculated in the step of calculating volume and the volume calculated through the whole food image data.

In some embodiments, the step of calculating volume (step S50) may further include a step of calculating volume of stacked food (step S51).

More specifically, a plurality of foods may be stacked in a specific space 510 within the tableware 500. Therefore, when it is recognized that different foods are stacked in a specific space 510 within the tableware 500, the calculation unit 140 calculates the volume of the foods located on the lower side by using image data of the foods located on the upper side, the calculated volume information, and the size, depth, and capacity information of the space 510.

Referring to FIG. 4, it may be possible to calculate volume of area where food (e.g., boiled rice) located on the lower side is covered by food (e.g., a fried egg) located on the upper side by calculating the area where the food (e.g., boiled rice) located on the lower side is covered by the food (e.g., a fried egg) located on the upper side and calculating a height of the area covered by the food (e.g., a fried egg) located on the upper side using the height of the area not covered by the food (e.g., a fried egg) located on the upper side among food (e.g., boiled rice) located on the lower side.

To this end, the height of the area where the food (e.g., boiled rice) located on the lower side is covered by the food (e.g., a fried egg) located on the upper side may be set as an average of the height of the area where the food (e.g., boiled rice) located on the lower side is not covered by the food (e.g., a fried egg) located on the upper side, but it is not limited thereto.

In some embodiments, data on foods (e.g., fried eggs, baked fish, seasoned laver, etc.) likely to be stacked on top of other foods may be previously stored in the database 170 of the computer. For example, data on foods mainly staked on the upper side of the food may include volume data or weight data, and through this, the calculation unit 140 may quickly calculate the volume of the food stacked on the upper side.

Meanwhile, the step of calculating volume (step S50) may further include a step of correcting, by the correction unit 150, a noise component photographed together with a tableware in a tableware image (step S52). That is, it may further include a step that the correction unit 150 detects a noise component that is not food and has a volume in the image data of the tableware containing food and performs correction to exclude the volume of the detected noise component from the calculated food volume in the process of calculating volume of each food.

Here, the noise component is not food and has a volume, and the volume of the food may be calculated larger than the actual volume due to the volume of the noise component. Therefore, the correction unit 150 may recognize the noise component in the photographed image in order to accurately calculate the volume of the food and perform correction to exclude the volume of the noise component from the volume of the food calculated by the calculation unit 140.

For example, a hand or cutlery (e.g., a spoon, a fork, a knife, etc.) may be a noise component that is not food and has a volume, and a lid of a dairy product may correspond to this, but it is not limited thereto. For example, noise information on an object corresponding to a noise component may be previously stored in the database 170 of the computer, and the correction unit 150 may recognize a noise component in the photographed image and perform correction to exclude the volume of the noise component from the volume of food calculated by the calculation unit 140.

In one embodiment, the correction unit 150 may pre-learn the image data for empty tableware 500, hands, or cutleries, and if tableware image includes hands or cutleries, the correction unit may recognize them and perform correction to exclude the volume of the hands or cutleries.

Next, referring to FIG. 1, the calculation unit 140 calculates meal information including the weight of each food by using the volume information and food information of each food calculated in the step S50 (step S60).

The database 170 of the computer has stored food information including weight per volume for each food, calorie information per weight for each food, and nutrition facts per weight for each food.

Foods have different weight per volume depending on the type, and their calories are different from each other. Accordingly, in an embodiment of the present invention, food information including weight per volume for each food is stored in the database 170, and using this, the calculation unit 140 calculates weight of food from volume information of food.

Using this, after the step of calculating weight (step S60), the calculation unit 140 may calculate calories of food accommodated in a user's serving tableware using the calculated weight information of each food, and in addition, calculate nutritional component information eaten by the user, and calculate additional specific information such as allergy precautions based on food or nutritional components included in the food.

Besides, the calculation unit 140 may calculate price information for corresponding food by using the type of food and the volume or weight of each food.

The calculation unit 140 may provide information included in the above-described meal information to a display unit 210 of the device for measuring food 200 or a display unit 310 of the user terminal 300. The UI of the screen provided on the display units 210 and 310 will be described later.

For example, the calculation unit 140 may provide different information to be displayed on the display unit 210/310 of the food serving section and the display unit 210/310 of the tableware return section. For example, the display unit 210/310 of the food serving section may display information on the type of food, information on calories, nutritional component information, allergy information and price information, and the display unit 210/310 of the tableware return section may additionally display information on an amount actually eaten in addition to the above information. However, the meal information calculated by the calculation unit 140 is not limited thereto, and various information may be displayed without limitation by using photographed information or information stored in the database 170.

Accordingly, the taker may make payment through a payment unit 240 of the device for measuring food 200 or the user terminal 300 by cash, card, account transfer, QR code tagging, RFID tagging, or facial recognition, etc. according to the price information provided.

In an embodiment, a restaurant may have a weighing device (not shown) capable of measuring the weight of the tableware 500, but it is not limited thereto, and it may further include a step that the receiving unit 110 receives the weight information of the tableware 500 measured from the weighing device (not shown) provided in the restaurant, and a step that the correction unit 150 corrects the weight of each food by matching the total weight of each food and the weight of the empty tableware calculated with the received weight information.

The above-described correction step can be selectively adopted and used, and since the weight may be measured differently from the actual weight due to the user's hand or various factors in the process of measuring the weight, if the weight information is measured differently to the extent that it exceeds threshold value, the correction step may not be performed.

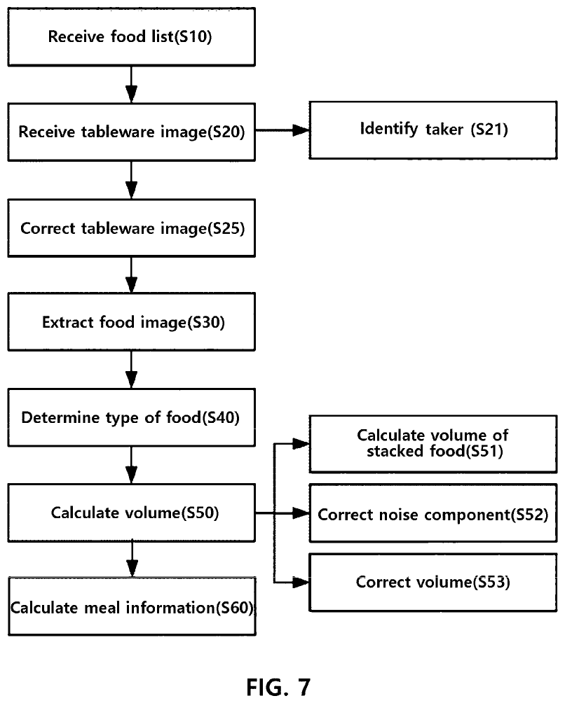

Hereinafter, a method for measuring food according to another embodiment of the present invention that uses the user terminal 300 as the device for measuring food 200 will be described with reference to FIG. 7. However, the difference from the method for measuring food according to an embodiment of the present invention will be mainly described, and description of the same content will be omitted.

The method for measuring food according to another embodiment of the present invention is performed by a computer, wherein the computer refers to a server for measuring food 100 or a user terminal 300. That is, the photographing may be performed by the user terminal 300, but other steps may be performed by the server for measuring food 100 or the user terminal 300.

Here, the user terminal 300 is a portable mobile terminal, in which a service application related to a method for measuring food is installed. The user terminal 300 may acquire image data and depth data. To this end, the user terminal 300 may include at least one of an RGB camera, a 2D camera, a 3D camera, a Time of Flight (ToF) camera, a light field camera, a stereo camera, an event camera, and an infrared camera. For example, the user terminal 300 may include all user devices capable of installing and executing a food measurement application related to the server for measuring food 100 or the device for measuring food 200.

First, referring to FIG. 7, a receiving unit 110 receives an image of tableware taken through a photographing unit 350 of the user terminal 300 at step S20.

Here, food may be photographed according to a request to shoot a photograph of a service application installed in the user terminal 300, and a guide for a method of photographing food, an angle, etc. may be provided to the service application user as by video or sound.

In an embodiment, the service application may request to shoot food two times or more from different angles when not using the 3D camera or ToF camera.

Subsequently, referring to FIG. 7, a correction unit 150 may perform image correction of the tableware image at step S25.

In an embodiment, in the step of receiving the tableware image (step S10), tilt information of the user terminal 300 measured through a gyro sensor (not shown) of the user terminal 300 may be received when food is photographed through the photographing unit 350 of the user terminal 300. The correction unit 150 may correct the tilt of the photographed image data of tableware containing food by using the tilt information of the user terminal 300.

According to an embodiment of the present invention, since a certain angle of tilt may occur in the process of photographing food through the photographing unit 350 by the user holding the user terminal 300, the above-described steps may be performed to correct the image data of tableware containing food into a horizontal state.

Next, referring to FIG. 7, an extraction unit 120 extracts food image data accommodated in space 510 of the tableware 500 from the image data of tableware containing food at step S30.

Since the tableware image photographed by the user terminal 300 may not contain only food, only food image data is extracted from the image at this step for accurate volume calculation.

The extraction unit 120 accurately extracts food from the background using a function of recognizing and extracting food from the background, and separates and extracts each image data of two or more foods when two or more foods are included, and in this process, a model learned using an artificial intelligence algorithm may be used.

Next, referring to FIG. 7, a determination unit 130 determines a type of each food based on the extracted food image data at step S40.

The determination unit 130 determines the food type of each food image data extracted by the extraction unit 120 using a model learned using an artificial intelligence algorithm. In some embodiments, if a plurality of determination results with similar accuracy are obtained, the determination unit 130 may output the plurality of determination results to the user terminal 300 and request the user to input or select a suitable result through the service application of the user terminal 300.

Next, referring to FIG. 7, a calculation unit 140 calculates a volume of each food by using height information for each pixel (i.e., 3D distance data) of the extracted food image data at step S50.

The step of calculating volume (step S50) may include a step of correcting volume (step S53). In an embodiment, a background target may be used for volume correction in the step of correcting volume (step S53).

In the step of correcting volume (step S53), the determination unit 130 may recognize the background target included in the received tableware image, and the correction unit 150 may correct the volume of each food calculated in the step S50 based on size information and location information of the recognized background target.

The correction unit 150 may perform volume correction of each food by comparing the background target and height information of each food, or may perform volume correction of each food by comparing the background target and size information of each food.

Here, the background target is photographed with food or separately photographed through the photographing unit 350, and a tableware 500 containing food; a table; a cutlery; and a user's fingers, etc. may be used as the background target. However, it is not limited thereto, and the background target may be applied to any target having a usual size. For example, the background target may be applied to any target whose size is determined, such as coins, bills, and smartphones (by product type). In some embodiments, information on the size of a background target photographed through the photographing unit 350 may be previously stored in a database 170.

As a first example, the service application may request the user to photograph the user's hand at a certain distance through the photographing unit 350. Alternatively, the service application may request to measure and input the actual size of the user's hand/finger.

In addition, the receiving unit 110 analyzes the user's hand image photographed and stores information on the actual size of the user's hand in the database 170.

Thereafter, when it is recognized that the user's hand is included in the received tableware image, the determination unit 130 may set the user's hand as a background target, and the correction unit 150 may correct the volume of each food calculated by the calculation unit 140 based on the location information and size information of the background target.

As a second example, the service application may request the user to photograph tableware 500, tables, cutleries, etc. used at home through the photographing unit 350 at a predetermined distance. In this case, the table may refer to a table or a rice table where the user places the tableware 500 and has a meal.

Specifically, the computer may analyze the image of the tableware 500 used by the user at home, photographed through the photographing unit 350 of the user terminal 300, and store information on the tableware 500 including size, depth, and capacity information of the corresponding tableware 500 in the database 170.

More specifically, since height information for each pixel is stored in the image photographed through the photographing unit 350 of the user terminal 300 according to an embodiment of the present invention, when the image data for the empty tableware 500 is received, the calculation unit 140 may calculate size, depth, and capacity information for the tableware using height information for each pixel of the image data of the tableware, which means to store them as the tableware information in the database 170.

In addition, as a result of analyzing food image, if food contained in the tableware 500 exists among the food image, the calculation unit 140 performs correction of the calculated volume of each food by using information on the size, depth, and capacity of the tableware 500 in which the corresponding food is accommodated.

As described above, if the size, depth, and capacity information of the corresponding tableware 500 is known, a more accurate result may be obtained by performing a correction step.

In some embodiments, the service application may request the user to measure the actual size of the tableware 500, the table, and the cutlery, etc. (e.g., information on the width, height, or perimeter of the table) and input them into the user terminal 300.

As a third example, a case of using a background target that is not related to food will be described. For example, the user may photograph a 500 won coin along with food, and input through the service application that a 500 won coin has been photographed as a background target.

Accordingly, the determination unit 130 recognizes the 500 won coin (background target) included in the tableware image including the received food, and the correction unit 150 corrects calculated volume of each food based on size information of the 500 won coin (background target).

In addition, the accuracy may be increased by correcting the volume by variously utilizing location information (restaurant, food service, etc.), weather information (ultraviolet rays, reduction of food type), user's status information (during diet, exercise, fighting disease, medication, etc.), personal preference information, and peripheral device information.

As a fourth example, the computer may build up big data by storing image data photographed through the user terminals 300 of a plurality of users, information calculated through the image data, and information on restaurants that match the places where the images were photographed.

For example, if user D photographed food at a location matching restaurant B and transferred the food image data, the location information is matched with big data to determine that user D was located at restaurant B, and correction for the calculated volume information may be performed by inquiring the previous result data matching the ordered menu.

In this regard, the opposite is also possible. More specifically, if data about food is stored first and it is known what kind of food a user ordered and ate when the user is paying, inversely, the stored data may be retrieved so as to record volume and nutrition information.

Next, referring to FIG. 7, the calculation unit 140 calculates meal information including the weight of each food by using the volume information and food information of each food calculated in the step S50 (step S60).

Using the method for measuring food according to according to an embodiment of the present invention, the computer may measure the amount of food served (meaning the amount of food before meals) and the amount of leftover for each taker at a restaurant or at home, and using this, may calculate the amount of food eaten.

In addition, the computer may generate operating information for restaurants and management information for takers by using the amount of food served, the amount of leftover, and the amount of food eaten for takers eating at restaurants or at home, and the management information for takers may include, for example, user's nutritional status, eating habits, and whether the user eats only what one wants, etc.

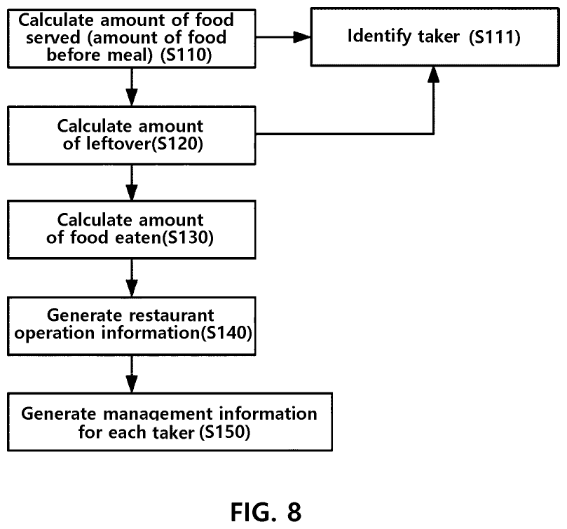

Hereinafter, a method of providing restaurant operation information and management information of a taker according to an embodiment of the present invention will be described with reference to FIG. 8. FIG. 8 is a flowchart of a method of providing restaurant operation information and management information of a taker according to an exemplary embodiment of the present invention.

First, referring to FIG. 8, the receiving unit 110 acquires pre-meal tableware data (pre-meal tableware image data) photographed through the food serving section photographing unit 250 of the food serving section or the photographing unit 350 of the user terminal 300, and using this, the calculation unit 140 calculates the amount of food served for a taker at step S110. A detailed description is the same as described with reference to FIGS. 1 to 8, and a step of identifying a taker (step S111) may be performed together. Here, the pre-meal tableware refers to the tableware 500 in a state in which food is contained in the tableware 500 of the taker before starting meal.

Next, referring to FIG. 8, the receiving unit 110 acquires post-meal tableware data (post-meal tableware image data) photographed through the tableware return section photographing unit 250 of the tableware return section or the photographing unit 350 of the user terminal 300, and using this, the calculation unit 140 calculates the amount of leftover for the taker at step S120. A detailed description is the same as described with reference to FIGS. 1 to 8, and a step of identifying a taker (step S111) may be performed together. Here, the post-meal tableware refers to the tableware 500 of the taker after a meal.

Next, referring to FIG. 8, the calculation unit 140 calculates an amount of food eaten of the taker by using the calculated an amount of food served and an amount of leftover at step S130.

Through steps S110 to S120, the computer may obtain information such as how much the taker ate meal and how much the taker left meal by calculating the amount of food served, the amount of food eaten, and the amount of leftover of the taker for each food menu provided by the restaurant.

In addition, the computer according to an embodiment of the present invention may perform the following operations to improve the accuracy of calculating the amount of food.

In an embodiment, the calculation unit 140 verifies whether the sum of the amount of food eaten and the amount of leftover of the taker calculated through the above steps matches the amount of food served, and if there is a discrepancy according to the verification result, the calculation unit 140 may correct at least one of the amount of food served, the amount of leftover, and the amount of food eaten calculated through the above steps so that the sum of the amount of food eaten and the amount of leftover matches the amount of food served, and records the result in the database 170.

In an embodiment, the calculation unit 140 verifies whether the sum of the total amount of food eaten and the total amount of leftover of takers at a restaurant calculated through the above steps matches the total amount of food served, and if there is a discrepancy according to the verification result, the calculation unit 140 may correct at least one of the total amount of food served, the total amount of leftovers, and the total amount of food eaten calculated through the above steps so that the sum of the total amount of food eaten and the total amount of leftover matches the total amount of food served, and records the result in the database 170.

In addition, the calculation unit 140 verifies whether the sum of the total amount of food eaten and the total amount of leftovers of takers at the restaurant calculated through the above steps matches the total amount of food served, and records the result in the database 170. More specifically, the calculation unit 140 verifies whether the difference value between the total amount of food served and the total amount of leftovers of the takers eating at the restaurant matches the total amount of food eaten.

In addition, the calculation unit 140 performs verification by comparing the total amount of food prepared at the restaurant with the sum of the total amount of leftovers generated by the takers at the restaurant, the total amount of remaining food not served at the restaurant, and the total amount of food eaten by the takers at the restaurant, and if there is a difference according to the verification result, the calculation unit 140 may correct at least one of the total amount of leftovers, the total amount of remaining food, and the total amount of food eaten so that the total amount of food prepared at the restaurant matches the sum of the total amount of leftovers generated by the takers at the restaurant, the total amount of remaining food not served at the restaurant, and the total amount of food eaten by the takers at the restaurant, and record the result in the database 170.

Here, the amount of leftover may be the amount of food left by the taker after being served to the taker, and the amount of remaining food may be the amount of food left without being served to the taker, and the amount of remaining food may be calculated through the above steps or through a separate method.

In addition, the database 170 may store a result of measuring the total weight of the amount of food prepared for each serving at the restaurant, the total volume (weight) of the remaining food, and the total weight of the leftovers, and the calculation unit 140 performs verification by comparing the total volume (weight) of the prepared food with the sum of the total volume (weight) of the amount of leftovers, the total volume (weight) of the amount of remaining food, and the total amount of food eaten by the takers at the restaurant calculated through the above steps, and if there is a difference according to the verification result, the calculation unit 140 may correct the total amount of food eaten by the takers calculated through the above steps so that the total amount of food prepared at the restaurant matches the sum of the total amount of leftovers generated by the takers at the restaurant, the total amount of remaining food not served at the restaurant, and the total amount of food eaten by the takers at the restaurant, and record the result in the database 170.

In this way, the calculation unit 140 may identify and improve problems by performing verification using various types of information and recording the accuracy due to calculation/correction.

Meanwhile, in order to accurately calculate the amount of food eaten, pictures must be taken before and after meal, but there may be a case where the user does not accidentally take a picture after meal.

Therefore, if the calculation unit 140 receives image data of tableware containing food before a meal and then does not receive a photographed post-meal tableware image data until a preset time lapses, the calculation unit determines that the post-meal tableware image data has not been photographed, and calculates the user's expected amount of food eaten.

For example, the calculation unit 140 may calculate the expected amount of food eaten by the user by regarding that the user has not left a leftover, or may calculate the expected amount of food eaten by the user based on information such as an average amount of food eaten by the user, status information (e.g., during diet, increasing weight, exercise), degree of hunger, user preference about menus included in the pre-meal food image, and taste information of menus stored in the database 170, and store the calculated result in the database 170.

Next, referring to FIG. 8, a management unit 180 of the computer generates operation information of the restaurant based on the amount of food served, the amount of leftover, and the amount of food eaten for the takers registered in the restaurant at step S140.

Next, referring to FIG. 8, the management unit 180 of the computer generates management information for each taker based on the amount of food served, the amount of leftover, and the amount of food eaten for the takers registered in the restaurant at step S150.

Step S140 means generating operation information that helps the restaurant operation.

More specifically, a serving amount control module 181 of the management unit 180 uses information on the total prepared amount for serving prepared for serving at the restaurant, the total amount of food served for the takers who received serving, and the number of remaining takers who did not receive serving to calculate target serving amount per person for remaining takers and provide it to a restaurant manager device (not shown).

In this case, the restaurant manager may refer to a person in charge who designs a menu in the restaurant and serves food directly to the takers, a manager who manages the restaurant, or a dietitian of the restaurant. A restaurant manager device such as a display device 30 may be installed around food prepared to be served in front of the restaurant manager of the restaurant.

Accordingly, when the serving amount control module 181 provides information on the target serving amount per person for remaining takers on the restaurant manager display, the restaurant manager may use this to control the serving amount for the remaining takers. For example, the restaurant manager may raise the target serving amount per person for the remaining takers if the prepared amount for serving is sufficient compared to the number of remaining takers, and reduce the target serving amount per person for the remaining takers if the prepared amount for serving is insufficient compared to the number of remaining takers.

In an embodiment, the operation information generation step (step S140) may include a step that a serving group management module 183 checks the affiliation of each personnel to be served, stores the amount of food served, the amount of leftovers, and the amount of food eaten for each affiliation and using this, generates information for each affiliation including at least one of preferred food, non-preferred food, amount of leftovers, nutritional status for each affiliation; and a step that extracts correlation information by matching the weather, the day of the week, schedule information for each affiliation, and the information for each affiliation.

Accordingly, according to an embodiment of the present invention, it may be not only possible to identify taste preference for food for each affiliation using information on preferred food and non-preferred food depending on the affiliation of the takers, but also to prepare an accurate guide for the next serving menu by analyzing correlation between the weather, the day of the week, schedule information for each affiliation, and an amount of food eaten.

In an embodiment, in the operation information generation step (step S140), if the serving amount is similar for each restaurant, but the difference in the amount of leftovers differs by more than a certain amount, the management unit may determine that the restaurant having smaller amount of leftovers has excellent food ingredient grades and cooking methods, and provide information on food ingredient supply and demand and cooking methods of the corresponding restaurant to restaurant manager devices of other restaurants.

Accordingly, the management unit may exert an effect of improving quality of restaurants by providing information on food ingredient supply and demand and cooking methods of the restaurant having smaller amount of leftover.

In an embodiment, the management information generation step (step S150) includes a step that a taker management module 185 generates information for each taker including at least one of preferred food, non-preferred food, an average amount of leftover, nutritional status, an average amount of food eaten by using body information, an amount of food served, amount of leftover, and an amount of food eaten for each taker.

In addition, the management information generation step also includes a step that the taker management module 185 calculates physical strength management information and risk of obesity for each taker using the information for each taker, and if the amount of food eaten of a taker not set as a diet state decreases below a certain amount for a certain period of time or the amount of leftover of the taker increases above a certain amount for a certain period of time, the taker is set as a subject of attention.

Therefore, if the amount of food eaten of a taker not set as a diet state decreases below a certain amount for a certain period of time or the amount of leftover of the taker increases above a certain amount for a certain period of time, the taker management module 185 determines that the taker has a problem causing a decrease in appetite, and set the taker as a subject of attention. Through this, there is an effect that it is possible to prepare countermeasures such as consultation by a manager by early detection of danger signs before an accident occurs to personnel such as protective-concerned soldiers in a place such as the military.

In an embodiment, the operation information generation step (S140 step) includes a step that average preferred food, non-preferred food, and an amount of food eaten for takers are calculated and using this, a serving menu recommendation module 187 derives one or more recommended menus and prepared amount for serving of the restaurant and provides them to the restaurant manager device.

In addition, in order to implement such an algorithm, a degree of relevance for each food is stored in the database 170 of the computer. For example, if foods A, B, and C are highly related and the takers of the corresponding restaurant prefer food B, it may be determined that foods A and C are likely to be preferred.

At this time, the serving menu recommendation module 187 may derive a recommended menu using preference information and taste evaluation score of food menu to be described below.

In an embodiment, a serving menu evaluation module 189 of the management unit 180 generates operation information and management information based on the amount of food served, the amount of leftover, and the amount of food eaten, and evaluates a preference of each food menu and a taste evaluation score of the food served itself by using an amount of change in the amount of food served and an amount of change in the amount of leftover of each of the foods served. With this information, the restaurant manager can check whether there is a problem with the food preparation process.

The above-described configuration evaluates a score by using these features, and more specifically, it is determined based on the following criteria.

First, when a serving amount of a particular food is greater than a reference value and an amount of leftover is less than a reference value, the serving menu evaluation module 189 increases a preference of the corresponding food menu and increases a taste evaluation score of the corresponding food served itself.

Second, when the serving amount of a particular food is greater than the reference value and the amount of leftover is greater than the reference value, the serving menu evaluation module 189 increases the preference of the corresponding food menu and decreases the taste evaluation score of the corresponding food served itself.

Third, when the serving amount of a particular food is less than the reference value and the amount of leftover is less than the reference value, the serving menu evaluation module 189 decreases the preference of the corresponding food menu and increases the taste evaluation score of the corresponding food served itself.

Fourth, when the serving amount of a particular food is less than the reference value and the amount of leftover is greater than the reference value, the serving menu evaluation module 189 decreases the preference of the corresponding food menu and decreases the taste evaluation score of the corresponding food served itself.

In an embodiment, the taker management module 185 of the management unit 180 generates nutrition facts eaten by each taker based on the amount of food eaten by the takers, and derives and provides nutritional intake status information based on the nutrition facts generated at regular time intervals. In this case, the taker management module 185 may provide the derived information to a terminal of the taker, that is, the user terminal 300, a terminal of a guardian of the taker, a terminal of a manager of the taker, and a terminal of the restaurant manager, etc. In addition, rewards or penalties are provided according to changes in nutritional status and amount of leftover of each taker derived using the above information.

In addition, when the taker is a student or a patient who needs management by a guardian, the taker management module 185 of the management unit 180 may provide a pre-meal tableware image and a post-meal tableware image of the taker obtained through the photographing unit 250 to the terminal of the guardian of the taker. The taker management module 185 determines the nutritional status and eating habits of the student or patient based on their serving menu, data of an amount of food eaten, and an amount of basic metabolism.

The taker management module 185 may provide the information obtained and determined in this way to the user terminal 300 and the terminal of guardian of the taker, and at the same time, based on the nutritional status and eating habits of each taker, may derive a recommended menu good for the corresponding taker to eat at home and may recommend a nutritional supplement according to the situation.

In addition, the user's body information may be input through a service application installed in the user terminal 300, and the user's basic metabolism may be calculated using the body information.

In addition, by using the user's nutritional status and eating habit information derived as above, one or more food menus matching the user may be derived and provided through a service application, or the information may be provided in conjunction with other food ordering applications.

In this case, the service application may directly receive input of information on the user's preferred food and non-preferred food from the user, and may receive input of information on the user's allergy, disease, and the like and exclude foods that the user should not eat from the recommended menu.

In addition, using such information, the determination unit 130 may provide a warning (notification) to the service application when food that the user should not eat is included in the food image photographed through a photographing unit 55 of a portable device 50, thereby preventing users from accidentally eating the food.

The computer may collect data on the amount of food before meal, the amount of food eaten, and the amount of leftover at each meal of the user through the user terminal 300 and store the data in the database 170, thereby constructing information such as the user's nutritional status and eating habits, and may collecting data on the user's body information, and user's activity index, activity information, and exercise information collected through various health and exercise applications to construct the user's health care information.

In addition, by interlocking with other health management applications and medical information applications to collect user's medical information, the user's nutritional status, eating habits, health care information, and medical information may be used to derive and provide customized diet and health supplement information for the user, and products related thereto may be directly sold through a service application.

Hereinafter, a device and a server for implementing a method for measuring food according to an embodiment of the present invention will be described.

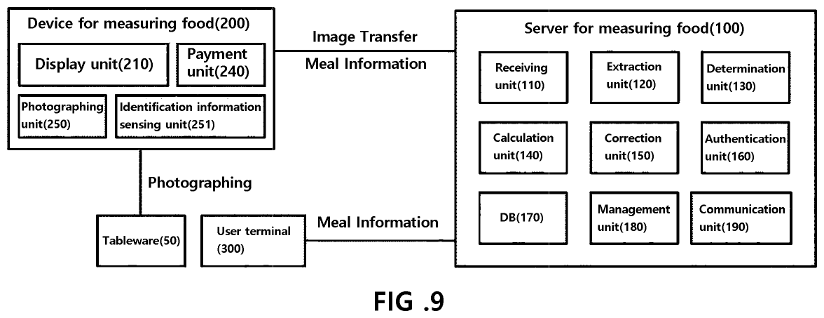

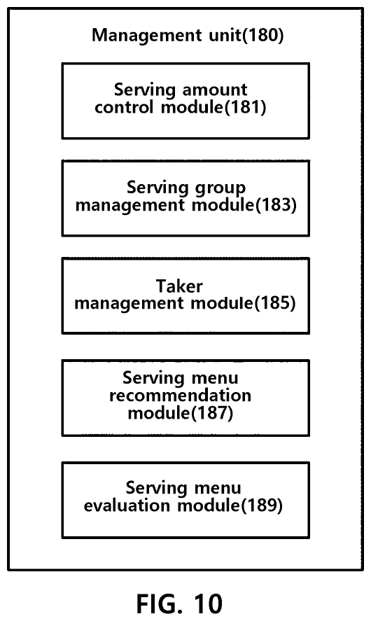

A server for measuring food 100 according to an embodiment of the present invention will be described with reference to FIGS. 9 and 10. FIG. 9 is a block diagram of a server for measuring food according to an exemplary embodiment of the present invention and FIG. 10 is a detailed block diagram of the management unit of FIG. 9.

Referring to FIG. 9, a server for measuring food 100 according to an embodiment of the present invention includes a receiving unit 110, an extraction unit 120, a determination unit 130, a calculation unit 140, a correction unit 150, an authentication unit 160, a database 170, a management unit 180, and a communication unit 190.

However, in some embodiments, the server 100 may include fewer or more components than the components illustrated in FIG. 9.

The receiving unit 110 receives a tableware image photographed through one or more photographing units 250.

The extraction unit 120 extracts food image data accommodated in each space 510 of the tableware 500 from the image data of tableware containing food.

The determination unit 130 determines a type of each food based on the extracted food image data.

The calculation unit 140 calculates a volume of each food by using height information for each pixel of the extracted food image data.

The database 170 stores an empty tableware image, tableware information including size, depth, and capacity of a plurality of spaces 510 formed in the tableware 500, and food information including weight per volume for each food.

Referring to FIG. 10, the management unit 180 includes a serving amount control module 181, a serving group management module 183, a taker management module 185, a serving menu recommendation module 187, and a serving menu evaluation module 189, and the functions of each module are as described above.

The communication unit 190 performs communication so as to receive a photographed tableware image from the photographing unit 250 installed in the restaurant, and may play a role to transmit various information calculated and generated by the server 100 to a person in charge or the terminal of the user.

The authentication unit 160 identifies a user by authenticating user information received from devices such as the device for measuring food 200 and a kiosk device 30, and loads various information on the user.

In addition, information on the weight, calories, etc. of foods in the serving tableware calculated through the calculation unit 140 of the server 100 is provided to the terminal of the user authenticated through the authentication unit 160. In this case, the information may be provided through a service application provided by the server 100 itself.

Since the server for measuring food 100 according to an embodiment of the present invention described above differs from the method for measuring food described with reference to FIGS. 1 to 8 only in the category of the invention and the contents are the same, duplicate descriptions and examples are omitted.

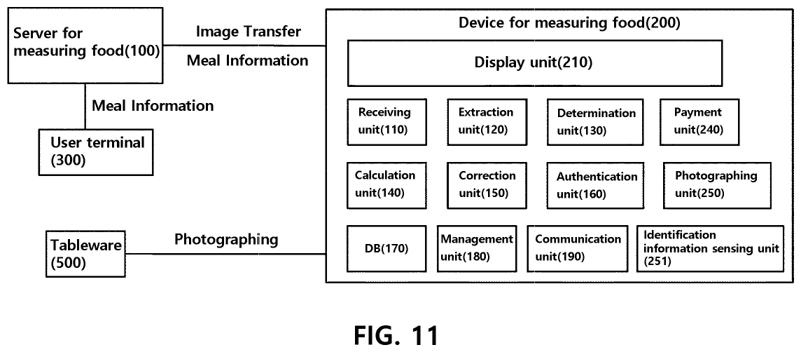

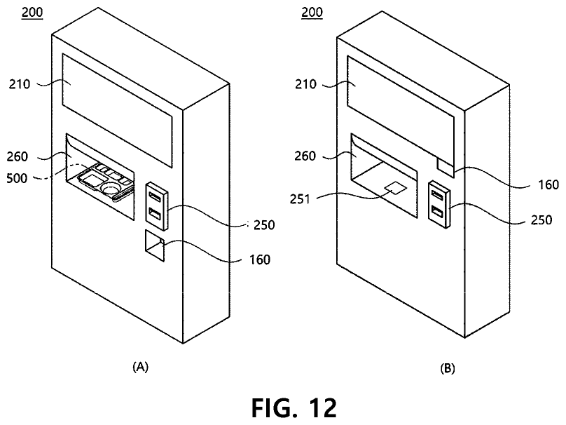

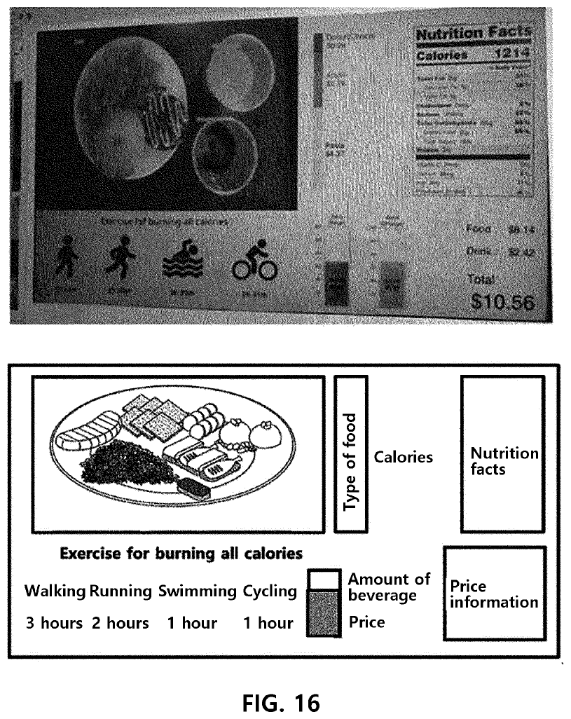

Hereinafter, FIG. 11 is a block diagram of a device for measuring food according to an exemplary embodiment of the present invention, FIGS. 12 to 15 are perspective views of devices for measuring food according to an exemplary embodiment of the present invention, and FIG. 16 is a screen of a device for measuring food according to an exemplary embodiment of the present invention.

The device for measuring food 200 may be provided at a place where food is served, and includes a receiving unit 110, an extraction unit 120, a determination unit 130, a calculation unit 140, a correction unit 150, an authentication unit 160, a database 170, a management unit 180. a communication unit 190, a display unit 210, a payment unit 240, and a photographing unit 250. However, in some embodiments, the device for measuring food 200 may include fewer or more components than the components illustrated in FIG. 11.

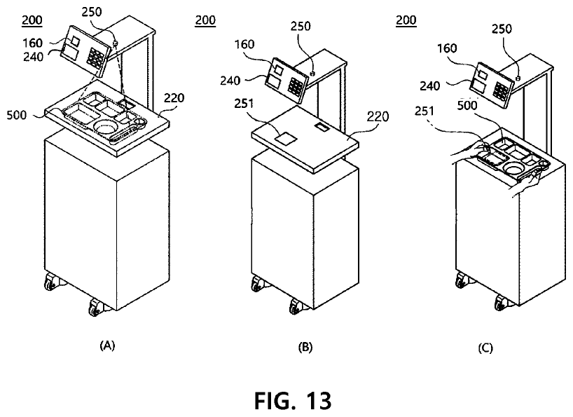

Referring to FIGS. 12 and 13, the device for measuring food 200 include a measuring area 220 or a plate 230 on which tableware 500 is placed. Referring to FIGS. 12 and 13, the photographing unit 250 photographs the tableware 500 placed on the measuring area 220 or the plate 230.

In addition, the measuring area 220 or the plate 230 include a weight measuring device (not shown) formed therein to measure the weight of the serving tableware placed on the upper surface thereof.

The receiving unit 110 receives a tableware image photographed through one or more photographing units 250. Here, the photographing unit 250 is positioned so that an upper surface of the tableware 500 may be photographed from the upper side over the tableware 500, and if an identification information sensing unit 251 is present, the identification information sensing unit 251 may be positioned so that identification information of the tableware 500 may be detected from the upper side, the lower side, or the side at the same time as the tableware 500 is photographed by the photographing unit 250.

The food measuring device 200 may include a display unit 210, receive input of user authentication information for authenticating a user, and display a photographed image through the display.

In addition, when the device for measuring food 200 is provided in the form of FIG. 12 and the user places the tableware 500 on the measuring area 220, the photographing unit 250 provided in the measuring area 220 may photograph the tableware to obtain a tableware image and a post-meal tableware image. And the device for measuring food 200 may include a payment unit 240 so that a user may measure food and pay at the same time.

In some embodiments, referring to FIG. 13 (C), the device for measuring food 200 may not include the plate 230, and the photographing by the photographing unit 250 and the detection by the identification information detecting unit 251 may be performed while a taker is holding the tableware 500.

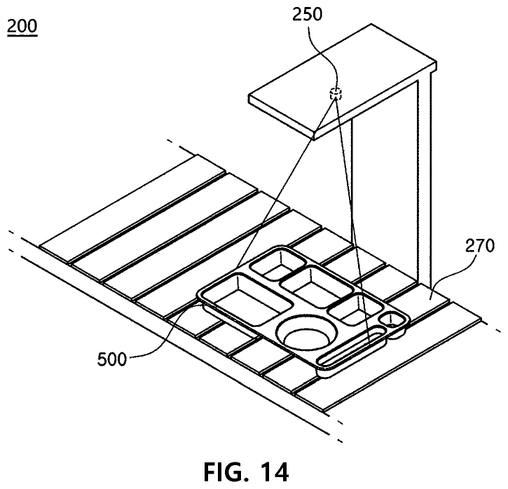

In some embodiments, referring to FIG. 14, the device for measuring food 200 may be installed in a tableware return section in which a conveyor belt 270 is installed.

In the process of moving the tableware 500 by the conveyor belt 270, the photographing unit 250 may photograph the tableware 500 from the upper side over the tableware 500.

In some embodiments, the device for measuring food 200 may include a photographing unit 250, an identification information sensing unit 251, and an authentication unit 160, and the photographing unit 250 may be located in a relatively highest region, the authentication unit 160 may be located between the photographing unit 250 and the identification information sensing unit 251, and the identification information sensing unit 251 may be located in a relatively lowest region. Since the device for measuring food 200 has such a structure, the photographing unit 250, the identification information sensing unit 251, and the authentication unit 160 may obtain necessary information from the taker and the tableware 500 just by the taker stopping in front of the device for measuring food 200. And this may reduce inconvenience of the taker.

The photographing unit 250 is positioned in the highest region for the purpose of photographing the tableware 500 from above. Assuming that the authentication unit 160 recognizes the face of the taker, when the taker holds the tableware 500, the tableware 500 is located below the face of the taker, so the authentication unit 160 may be positioned relatively above the identification information sensing unit 251. Here, identification information 530 of the tableware 500 may be located on the side of the tableware 500 and may be recognized by the identification information sensing unit 251 when the taker stands while holding the tableware 500.

Meanwhile, the identification information sensing unit 251 and the authentication unit 160 may not always operate, but may only operate when the tableware 500 is photographed by the photographing unit 250, and through this, the recognition of the tableware 500 by the photographing unit 250 becomes a kind of enabler, thereby effectively operating the identification information sensing unit 251 and the authentication unit 160.

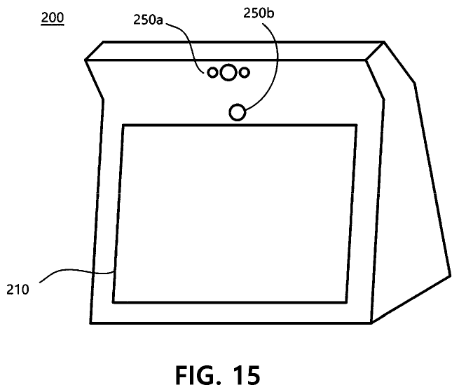

Referring to FIG. 15, the device for measuring food 200 may be set standing on a table or hung on a wall. A display unit 210 is positioned on front of the device for measuring food 200, and a photographing unit 250a for photographing food or tableware containing food and a photographing unit 250b for photographing biometric information of a taker are positioned on front of the device for measuring food 200.

The device for measuring food 200 may be tilted with its upper part toward the front, and the photographing unit 250a for photographing food or tableware containing food may be positioned in the tilted area of the device for measuring food 200 to photograph the tableware 500 located below. Although the photographing unit 250b for photographing biometric information of a taker is shown not to be in the tilted area, it may be located in the tilted area.

And when the taker photographs the tableware 500 containing food with the device for measuring food 200 or the user terminal 300, the screen of FIG. 16 may be displayed on the display unit 210/310.

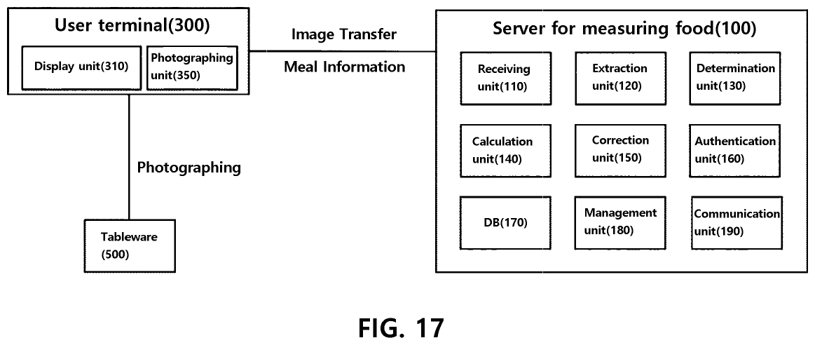

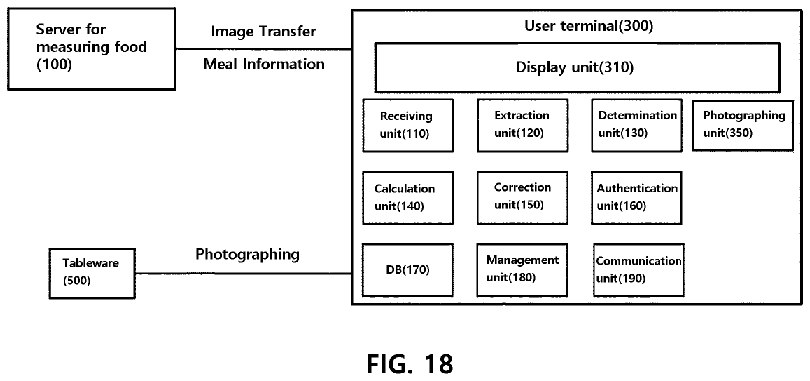

For example, a tableware image containing food photographed by the photographing unit 250/350 may be displayed, and information on a type of food and calories according to the type of food may be displayed. And when a beverage and the like is contained in a cup, the height of the beverage in the cup may be displayed. In addition, information on exercise and exercise time required to burn calories from eating food may also be displayed together. Besides, nutrition facts and price information of the food to be consumed may also be displayed together. In addition, since FIGS. 17 and 18 are only different in that the user terminal 300 performs the role of the device for measuring food 200 compared to FIGS. 9 and 11, detailed descriptions are omitted.

Since the detailed contents of the device for measuring food 200 configurations according to an embodiment of the present invention described above differs from the method for measuring food described with reference to FIGS. 1 to 8 only in the category of the invention and the contents are the same, duplicate descriptions and examples are omitted.

The method for measuring food according to an embodiment of the present invention described above can be embodied as a program (or application) to be executed in combination with a server which is hardware, and can be stored in a medium.

The above-described program may include a code coded in a computer language such as C, C++, JAVA, and machine language readable by a computer's processor (CPU) in order for the computer to read the program and execute the methods embodied as a program. Such code may include a functional code related to a function and the like that defines necessary functions for executing the methods, and may include a control code related to an execution procedure necessary for the processor of the computer to execute the functions according to a predetermined procedure. In addition, such code may further include a code related to a memory reference to which location (address number) of the internal or external memory of the computer should be referenced for additional information or media required for the processor of the computer to execute the functions. In addition, when the processor of the computer needs to communicate with any other computer or server in a remote location in order to execute the functions, the code may further include a communication related code for how to communicate with any other computer or server in a remote location using a communication module of the computer and what information or media to be transmitted and received during communication and the like.

The storage medium refers not to a medium that stores data for a short moment, such as a register, cache, memory, etc., but refers to a medium that stores data semi-permanently and can be read by a device. Specifically, examples of the storage medium include, but are not limited to, ROM, RAM, CD-ROM, magnetic tape, floppy disk, and optical data storage device. That is, the program may be stored in various recording media on various servers to which the computer can access, or in various recording media on the user's computer. In addition, the medium may be distributed over computer systems connected through a network, and may store a code readable by the computer in a distributed manner.

In the above, embodiments of the present invention have been described with reference to the accompanying drawings, but it will be understood by those of ordinary skill in the art that the present invention may be implemented in other specific forms without changing the technical spirit or essential features. Therefore, the embodiments described above are exemplary in all aspects and should be understood as non-limiting.

What is claimed is:

1. A method for measuring food performed by a computer, comprising:
receiving image data of a tableware containing the food and depth data of the tableware containing the food, when the tableware containing the food is photographed by a photographing unit;
calculating a tilt of a tableware image from the image data of the tableware, and correcting the image data of the tableware containing the food and the depth data of the tableware containing the food according to the tilt to obtain corrected tableware image data and corrected depth data;
extracting a shape of the tableware using the corrected depth data of the tableware containing the food, and extracting food image data accommodated in the tableware from the corrected tableware image data;
determining a type of the food based on the food image data; and
calculating a volume of the food based on the corrected depth data of the tableware containing the food.

2. The method of claim 1, wherein the step of correcting the image data of the tableware containing the food and the depth data of the tableware containing the food comprises:
determining a plurality of points identified as flat areas among exposed areas of the tableware from the image data of the tableware, and calculating the tilt of the tableware image from the image data of the tableware using the plurality of points; and
correcting the image data of the tableware containing the food and the depth data of the tableware containing the food according to the tilt.

3. The method of claim 1, wherein the step of calculating the volume of the food further comprises correcting the volume of each food based on tableware information comprising a size of a space, a depth of the space and a capacity of the space, wherein the each food is accommodated in the space.

4. The method of claim 1, wherein the step of calculating the volume of the food comprises, when the type of the food accommodated in a specific space in the tableware is a liquid food, recognizing a position where the liquid food and a corresponding space contact in the tableware image and calculating a volume of the liquid food using information on the specific space.

5. The method of claim 1, wherein the step of calculating the volume of the food comprises, when different foods are stacked in a specific space within the tableware, calculating a volume of the different foods located on a lower side using image data of the different foods located on an upper side, the volume, and information of the specific space.

6. The method of claim 1, wherein the step of calculating the volume of the food further comprises detecting a noise component, wherein the noise component is not the food and the noise component has a volume in the image data of the tableware containing the food and excluding a volume of the noise component from the volume of the food.

7. The method of claim 6, wherein the computer further comprises a database, wherein the database stores noise information on an object corresponding to the noise component, and
the step of excluding the volume of the noise component comprises recognizing the noise component in the image data of the tableware containing the food based on the noise information.

8. The method of claim 1, wherein the computer comprises:
a database, wherein the database has built up big data by storing image data photographed through terminals of a plurality of users, information calculated through the image data, and information on restaurants matching places where images were photographed,
when an image of the food is received, the database matches location information where the image of the food was photographed and a determined type of food with the big data in the database, and the database detects a previous calculation result of matched details, and uses the matched details to correct the volume of the food.

9. The method of claim 1, wherein, when receiving at least one of biometric information of a taker photographed by the photographing unit or code information of the tableware, the computer identifies at least one of identification information of the taker or identification information of the tableware.

10. The method of claim 9, wherein the computer calculates an amount of the food eaten by the taker by calculating an amount of the food served based on a pre-meal tableware image data of the taker and calculating an amount of leftover based on a post-meal tableware image data of the taker.

11. The method of claim 10, wherein the computer verifies whether a sum of the amount of the food eaten and the amount of the leftover of the taker matches the amount of the food served, and the computer corrects at least one of the amount of the food served, the amount of the leftover, and the amount of the food eaten, wherein the sum of the amount of the food eaten and the amount of the leftover matches the amount of the food served if there is a discrepancy according to a verification result.

12. The method of claim 10, wherein the computer further comprises
a database, wherein the database stores information on an average amount of the food eaten by the taker and a food preference of the taker, and
if not receiving the post-meal tableware image data within a preset time, the computer determines that the post-meal tableware image has not been photographed and calculates an expected amount of the food eaten by the taker based on the information on the average amount of the food eaten by the taker and the food preference of the taker, a determined type of the food, and the volume of the food.

13. The method of claim 1, wherein the computer comprises a database, wherein the database stores determination reference information comprising at least one of food menu data, restaurant location data, date data, and time data, and
the step of determining the type of the food based on the food image data comprises determining a type of each food after deriving food list candidates by matching the food image data and food related information.

14. The method of claim 1, wherein the computer:
calculates the tilt of the tableware containing the food by analyzing the image data of the tableware containing the food,
calculates the tilt of the tableware containing the food by using the depth data of a plurality of points on the tableware containing the food,
calculates the tilt of the tableware containing the food based on a tilt of a reference target photographed or measured together with the tableware containing the food, or
calculates the tilt of the tableware containing the food based on a tilt of the photographing unit and a measuring device.

15. A server for measuring food, comprising:
a receiving unit configured to receive image data of tableware containing the food and depth data of the tableware containing the food, when the tableware containing the food is photographed by a photographing unit;
a correction unit configured to calculate a tilt of the tableware image from the image data of the tableware, and to correct the image data of the tableware containing the food and the depth data of the tableware containing the food according to the tilt to obtain corrected tableware image data and corrected depth data;
an extraction unit configured to extract a shape of the tableware using the corrected depth data of the tableware containing the food, and to extract food image data accommodated in the tableware from the corrected tableware image data;
a determination unit configured to determine a type of the food based on the food image data; and
a calculation unit configured to calculate a volume of the food based on the corrected depth data of the tableware containing the food.

16. A device for measuring food, comprising:
a receiving unit configured to receive image data of a tableware containing the food and depth data of the tableware containing the food, when the tableware containing the food is photographed by a photographing unit;
a correction unit configured to calculate a tilt of a tableware image from the image data of the tableware, and to correct the image data of the tableware containing the food and the depth data of the tableware containing the food according to the tilt to obtain corrected tableware image data and corrected depth data;
an extraction unit configured to extract a shape of the tableware using the corrected depth data of the tableware containing the food, and to extract food image data accommodated in the tableware from the corrected tableware image data;
a determination unit configured to determine a type of the food based on the food image data; and
a calculation unit configured to calculate a volume of the food based on the corrected depth data of the tableware containing the food.

17. A program stored in a medium for executing the method of claim 1 in combination with the computer, wherein the computer is hardware.
